(19) United States
(12) Patent Application Publication
(10) Pub. No.: US 2018/0198878 A1
(43) Pub. Date: Jul. 12, 2018

(54) SHARED SESSIONS THROUGH REVERSE PROXY

(71) Applicant: Hewlett Packard Enterprise Development LP, Houston, TX (US)

(72) Inventors: Andreas Keldenich, Ratingen (DE); Daniel Scott Jorgenson, Palo Alto, CA (US)

(21) Appl. No.: 15/401,368

(22) Filed: Jan. 9, 2017

(51) Int. Cl. H04L 29/08

(52) U.S. Cl. CPC H04L 67/2814; H04L 67/148; H04L 67/02

(57) ABSTRACT

In some examples, a reverse proxy system includes a network interface and a reverse proxy engine. The network interface may communicate with a web client and multiple web applications. The reverse proxy engine may maintain a shared session among the multiple web applications for the web client and update the shared session responsive to identifying a session attribute change specified in a response header of a response message from a particular web application among the multiple web applications

### BACKGROUND

With rapid advances in technology, computing systems are increasingly prevalent in society today. Vast computing systems execute and support applications that communicate and process immense amounts of data, many times with performance constraints to meet the increasing demands of users. Increasing the efficiency, speed, and effectiveness of computing systems will further improve user experience.

### BRIEF DESCRIPTION OF THE DRAWINGS

Certain examples are described in the following detailed description and in reference to the drawings.

FIG. 1 shows an example of a reverse proxy system that supports maintaining a shared session among multiple web applications.

FIG. 2 shows an example of an architecture that supports identification of changes to a shared session specified in response messages from proxied web applications.

FIG. 3 shows an example of an architecture that supports communication of changes to a shared session through request messages.

FIG. 4 shows an example of an architecture that supports maintaining a shared session among multiple application servers that redundantly host a web application.

FIG. 5 shows an example of an architecture that supports insertion of common-look webpage content through a reverse proxy system.

FIG. 6 shows a flow chart of an example method to maintain a shared session among multiple web applications through a reverse proxy system.

FIG. 7 shows an example of a system that supports maintaining a shared session among multiple web applications.

### DETAILED DESCRIPTION

The discussion below refers to reverse proxies. A reverse proxy may refer to any server, application, hardware-software combination, circuitry, or any other logic that retrieves resources on behalf of a client from one or more servers. The retrieved resources may be returned to the client by the reverse proxy in a manner as if the resources originated from the reverse proxy itself. In some examples, a reverse proxy may provide an interface or common access point to multiple web applications. The multiple web applications may be referred to as proxied applications, as the reverse proxy may serve as a proxy for the multiple web applications to web clients (e.g., web browsers) seeking to access the multiple web applications. The reverse proxy may control the exchange of network traffic between web clients and proxied web applications. As used herein, a reverse proxy system may refer to any system that implements a reverse proxy.

Examples consistent with the present disclosure may provide for reverse proxy systems that maintain shared sessions among proxied web applications through request and response messages. As described in greater detail herein, a reverse proxy system may parse response messages received from proxied web applications to identify changes in a shared session made by the proxied web applications. Such changes may be subsequently propagated to other proxied web applications via request messages sent from web clients to access the other proxied web applications. In doing so, reverse proxy systems may provide an efficient mechanism to maintain shared session state and propagate changes amongst proxied web applications. Other features provided herein include implementing load-balancing and supporting a common-look among proxied web applications through reverse proxy systems. These features are discussed in due turn.

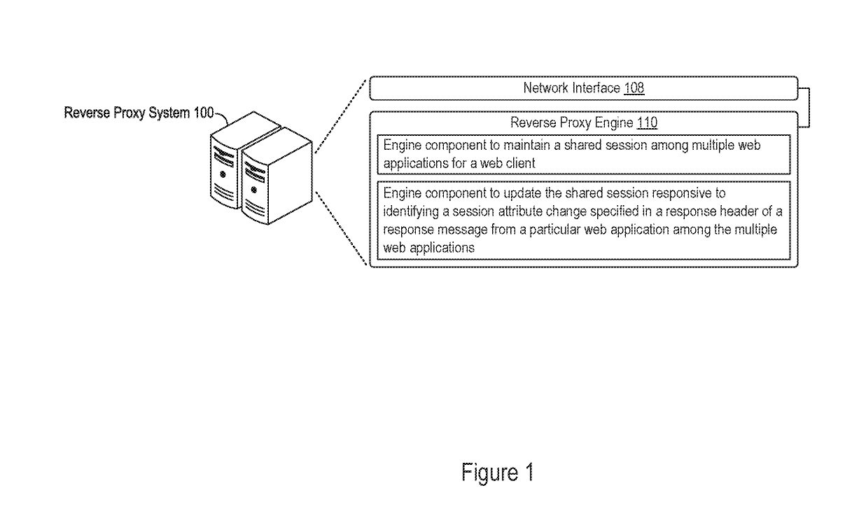

FIG. 1 shows an example of a reverse proxy system 100 that supports maintaining a shared session among multiple web applications. The reverse proxy system 100 may take the form of any computing system that includes a single or multiple computing devices such as servers, compute nodes, desktop or laptop computers, smart phones or other mobile devices, tablet devices, embedded controllers, and more.

Reverse proxy systems such as the reverse proxy system 100 may implement a reverse proxy that proxies multiple web applications to web clients seeking access to the multiple web applications. In some instances, reverse proxies may implement a portal through which web clients may interact with or otherwise access various web applications. The portal may include a portal application or a portal webpage, as examples. Through an implemented portal, a reverse proxy may serve as a front to the web applications, relaying request and response messages between web clients and proxied web applications.

The reverse proxy system 100 may maintain a shared session among web applications proxied by a reverse proxy. A shared session may be specific to a particular web client, e.g., a particular web browser application or a particular instance of a web browser application. To maintain a shared session among proxied web applications, the reverse proxy system 100 may store a session state object that represents the shared session. As described in greater detail herein, identification and propagation of changes to a shared session may be effectuated through request and response headers of messages relayed by a reverse proxy, for example through custom header fields of hypertext transfer protocol (HTTP) messages relayed by a reverse proxy between web clients and proxied web applications.

The reverse proxy system 100 may include various elements to provide or support any of the reverse proxy features described herein. In the example shown in FIG. 1, the reverse proxy system 100 includes a network interface 108 and a reverse proxy engine 110. The network interface 108 may link the reverse proxy system 100 to any number of communication networks, through which the reverse proxy system 100 may communicate with a web client and multiple web applications. As such, the network interface 108 may include network interface card (NIC), data ports, sockets, controllers, and the like. The reverse proxy engine 110 may be any hardware or hardware-software combination that implements the reverse proxy features described herein, including features with respect to maintaining a shared session among proxied web applications, providing application load-balancing, or supporting common look webpage content among proxied web applications.

The reverse proxy system 100 may implement the reverse proxy engine 110 (including components thereof) in various ways, for example as hardware and programming. The programming for the reverse proxy engine 110 may take the form of processor-executable instructions stored on a non-transitory machine-readable storage medium, and the processor-executable instructions may, upon execution, cause hardware to perform any of the features described herein. In that regard, various programming instructions of the reverse proxy engine 110 may implement engine components to support or provide the features described herein.

The hardware for the reverse proxy engine 110 may include a processing resource to execute programming instructions. A processing resource may include various number of processors with a single or multiple processing cores, and a processing resource may be implemented through a single-processor or multi-processor architecture. In some examples, the reverse proxy system 100 implements multiple engines (or other logic) using the same system features or hardware components, e.g., a common processing resource).

The reverse proxy engine 110 may implement any combination of the features described herein. As shown in the example of FIG. 1, the reverse proxy engine 110 may include engine components to maintain a shared session among the multiple web applications for the web client and update the shared session responsive to identifying a session attribute change specified in a response header of a response message from a particular web application among the multiple web applications.

These and other aspects of various reverse proxy features disclosed herein are described in greater detail next.

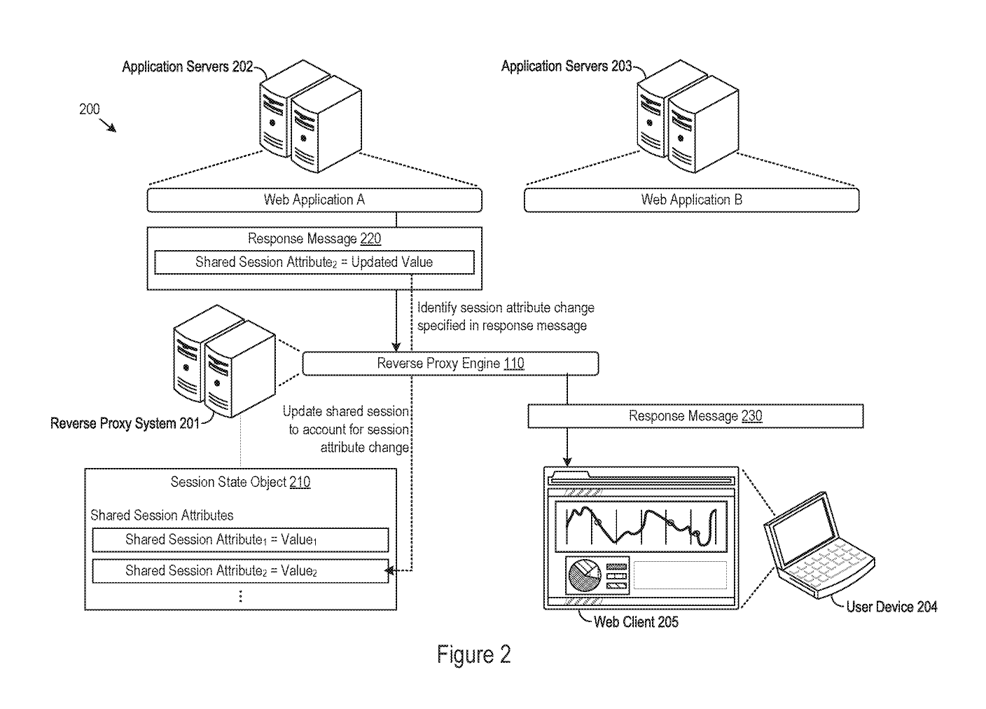

FIG. 2 shows an example of an architecture 200 that supports identification of changes to a shared session specified in response messages from proxied web applications. The example architecture 200 shown in FIG. 2 includes a reverse proxy system 201 that includes a reverse proxy engine 110, the application servers 202, the application servers 203, and a user device 204. The application servers 202 and 203 may host web applications proxied by the reverse proxy system 201. As illustrative examples in FIG. 2, the application servers 202 host a web application labeled as web application A and the application servers 203 host another web application labeled as web application B.

The reverse proxy system 201 may implement a reverse proxy (e.g., as part of the reverse proxy engine 110) that relays requests and responses between proxied web applications A and B and web clients, such as the web client 205 executing on the user device 204. In some examples, responses and requests may be relayed by the reverse proxy engine 110 in the form of HTTP request and response messages. The reverse proxy engine 110 may process received request and response messages in various ways prior to forwarding the messages on as part of the communication exchange between web clients and proxied web applications.

The reverse proxy engine 110 may maintain a shared session for the multiple web applications proxied by the reverse proxy system 201, including the web applications A and B shown in FIG. 2. The reverse proxy engine 110 may maintain shared sessions on a per-web client basis. That is, the reverse proxy engine 110 may store a specific session state object for each web client accessing proxied web applications. In the example shown in FIG. 2, the reverse proxy engine 110 tracks a shared session for the web client 205 through the session state object 210, which may be stored locally within the reverse proxy system 201. A session state object may store any data associated with a shared session for a particular web client, which may be referred to as shared session data. Some examples of shared session data are presented below.

As one example of shared session data, the session state object 210 specific to the web client 205 may store values for any number of shared session attributes. Shared session attributes may refer to any information, data, or characteristic indicative of a current state of the shared session. Shared session attributes may also be referred to as global attributes in that such information may be shared across multiple different web applications, as opposed to local attributes used (e.g., solely) by a particular proxied web application. In some examples, the specific shared session attributes tracked through the session state object 210 are configurable by the reverse proxy engine 110, the web applications, a system administrator, any users, or any combination thereof. Example shared session attributes may include a user identifier (e.g., an enterprise user ID or a customer login ID), a user e-mail address, a “product in focus”, a selected time period, a geographical location for a web client or user, a user time zone, a selected language, and many other possibilities.

In FIG. 2, the session state object 210 stores values for the shared session attributes labeled as Shared Session Attribute₁ and Shared Session Attribute₂, shown as Value₁ and Value₂ respectively. In some examples, the session state object 210 may further store a last-modified timestamp for each shared session attribute, which may specify a time when the current value of the shared session attribute was set. As described below, the reverse proxy engine 110 may use last-modified timestamps for shared session attributes to control how changes to the shared session are propagated amongst proxied web applications.

Returning to examples of shared session data, the session state object 210 may store application-specific data for proxied web applications. As an illustrative example, the session state object 210 may store a timestamp indicating a last-accessed time by the web client 205 as well as an application session ID (e.g., session cookie) for a particular web application. Regarding stored application session IDs for proxied web applications, the reverse proxy engine 110 may transparently manage the shared session with the web client 205 through a single proxy session ID, as opposed to multiple application session IDs for each proxied application. The reverse proxy engine 110 may assign or generate a proxy session ID for the web client 205 upon a first access to an implemented portal or proxied web application. After receiving a generated proxy session ID from the reverse proxy engine 110, the web client 205 may use the proxy session ID to reference the shared session shared across the proxied web applications (e.g., as specified in HTTP request messages). The proxy session ID may also be stored as a part of the session state object 210.

From the proxy session ID, the reverse proxy engine 110 may retrieve the session state object 210 and set the appropriate session ID in the request header for the particular web application being accessed. That is, the proxy session ID may be specific to the shared session, in effect acting as an identifier for the shared session of the web client 205. The web client 205 need not reference specific application session IDs for proxied web applications, and can simply indicate requests as part of the shared session through inclusion or reference to the proxy session ID. Other request and response cookies (e.g., set-cookies) may be relayed between the web client 205 and proxied web applications without change. Thus, the session state object 210 may store application-specific data such as application session IDs and last-accessed timestamps for a shared session of the web client 205.

While some examples of shared session data are presented above, the session state object 210 may include any additional or alternative data associated with a shared session. An illustrative example of shared session data that may be stored by the session state object 210 is shown as the following:

```
Shared Session
  Proxy Session ID = 50260109234B026CADFF25243-clt01766
Web Application A
  Application Session ID = 060052342AA26838A722F87AA-clt01243
  last-accessed timestamp = 2019-08-03 15:23:15.024
Web Application B
  Application Session ID = 09290DDE20A09234C0348BAC-clt01243
  last-accessed timestamp = 2019-08-03 15:26:03.123
Shared Session Attributes
  product_number = ”LP25”, last-modified timestamp = 2019-08-03; 15:26:04.347
  user_id = “mjj23”, last-modified timestamp = 2019-08-03; 15:18:35.938
  user_email = “mjj23@host.com”; last-modified timestamp = 2019-08-03: 15:18:35.938
```

### Example Shared Session Data

Although shared session data is shown for two example web applications A and B, the session state object 210 may store shared session data for any number of proxied web applications. Likewise, any number of additional or alternative shared session attributes may be tracked by the session state object 210.

The reverse proxy engine 110 may update the session state object 210 to account for changes to the shared session made by proxied web applications. In that regard, the reverse proxy engine 110 may detect session attribute changes, which may refer to a value change made by a proxied web application for any shared session attribute. Proxied web applications may be programmed to indicate session attribute changes in the response headers of response messages sent by the proxied web applications (e.g., in responding to request messages sent by the web client 205 and then relayed by the reverse proxy engine 110). Thus, the proxied web applications and reverse proxy engine 110 may use an existing transport mechanism (e.g., HTTP response messages) to specify and identify changes to a shared session.

One such example is shown in FIG. 2 through the response message 220 generated by web application A. The response message 220 generated by web application A may specifically indicate changes to a shared session made by web application A in responding to a request message originating from the web client 205. In the example in FIG. 2, the response message 220 specifies a session attribute change that updates the value of Shared Session Attribute₂ to an updated value (shown as “Updated Value” in FIG. 2). Proxied web applications may embed the session attribute changes into response headers for identification by the reverse proxy engine 110. In some examples, proxied web applications may represent session attribute changes in an object notation format such as the JavaScript Object Notation (JSON) format. Object notation strings representing session attribute changes may then be embedded into a response header of an HTTP response message, and specific keyword or flag strings may be included in the JSON string through which the reverse proxy engine 110 may identify session attribute changes.

Accordingly, the reverse proxy engine 110 may parse response headers of response messages sent from proxied web applications to identify changes to a shared session maintained by the reverse proxy engine 110. In doing so, the reverse proxy engine 110 may, in some examples, parse the response header of an HTTP response message to identify specific or custom fields configured to shared session data. In FIG. 2, the reverse proxy engine 110 may receive the response message 220 from web application A and parse the response message 220 to identify the specified session attribute change (i.e., setting Shared Session Attribute₂ to the updated value). Responsive to identifying the session attribute change, the reverse proxy engine 110 may update the session state object 210 to account for the session attribute change. In this example, the reverse proxy engine 110 may change the value of Shared Session Attribute₂ from Value₂ to the updated value as well as update the last-modified timestamp for Shared Session Attribute₂ to track the time at which the update occurred.

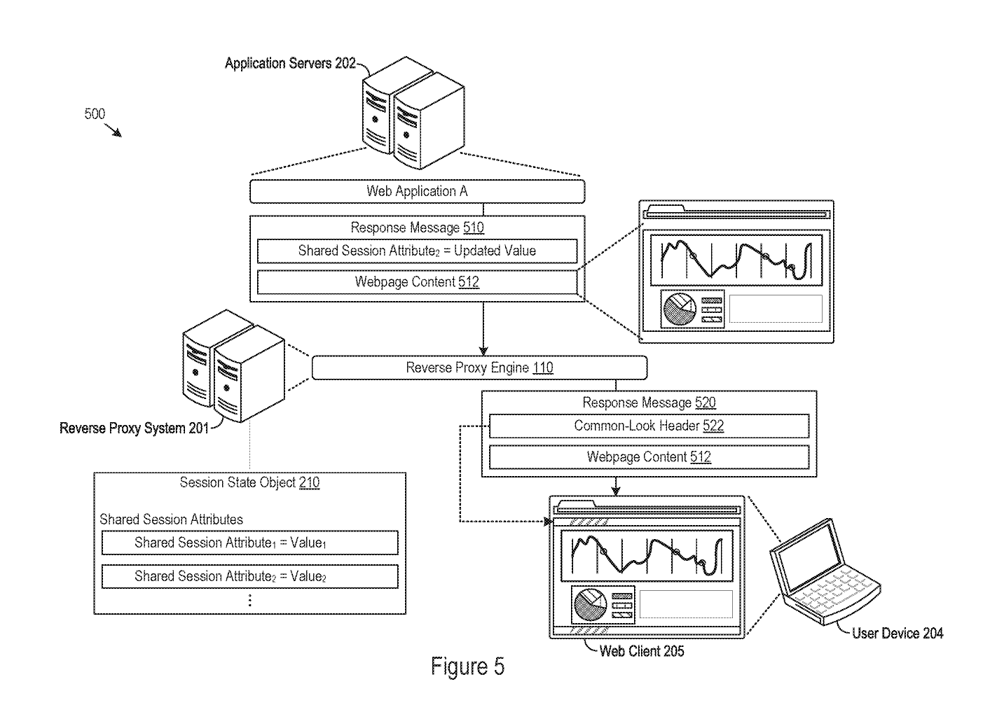

In some examples, the reverse proxy engine 110 may process the response message 220 prior to forwarding the response to the web client 205. For instance, the reverse proxy engine 110 may strip shared session-related content from the response header (such as JSON strings representing session attribute changes), replace the application session ID for web application A with the proxy session ID for the shared session of the web client 205, or perform any other reverse proxy-related processing. As another example processing of the response message 220, the reverse proxy engine 110 may insert or replace webpage content in the response message 220 with common-look content, as discussed in greater detail below with respect to FIG. 5. After processing, the reverse proxy engine 110 sends the response to the web client, shown in FIG. 2 as the response message 230.

Aside from proxied web applications, changes to a shared session may be made by any number of additional or alternative sources. For example, external or non-proxied applications may set session attribute values, e.g., through a user login application implemented as a plug-in application to a reverse proxy itself. An initial or updated value for shared session attributes like a user ID, user e-mail, preferred language, user location, and more may be specified by non-proxied applications and other sources. The reverse proxy engine 110 may identify changes to the shared session from any number of sources, and update the session state object 210 accordingly.

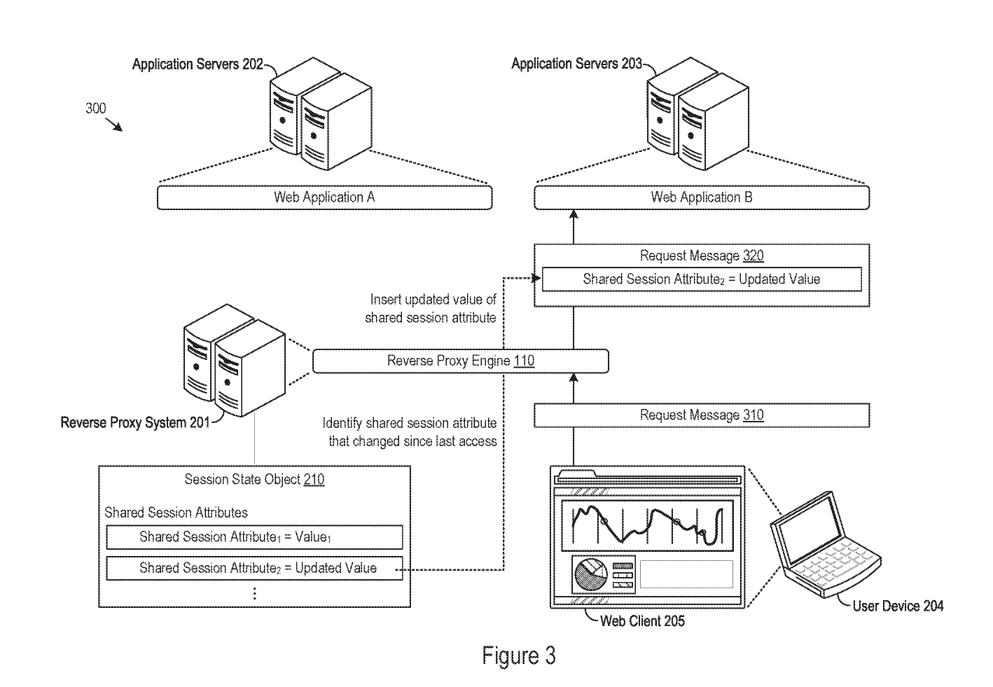

After detecting session attribute changes made by a particular proxied web application, other non-proxied applications, the web client 205, a reverse proxy itself, or any other source of session change, the reverse proxy engine 110 may selectively propagate the changes to the shared session to other proxied web applications. The reverse proxy engine 110 need not broadcast a session attribute change to all other proxied web applications and need not immediately communicate the session attribute change to other proxied web applications. Instead, the reverse proxy engine 110 may leverage request messages sent by the web client 250 to propagate specific shared session changes relevant for accessed web applications. These features are discussed in greater detail through FIG. 3.

FIG. 3 shows an example of an architecture 300 that supports communication of changes to a shared session through request messages. The architecture 300 shown in FIG. 3 includes a reverse proxy system 201, the applications servers 202 and 203, as well as a user device 204 executing the web client 205.

In operation, the reverse proxy engine 110 may propagate changes made to a shared session by a particular proxied web application to any number of other proxied web applications, and specifically through request messages directed to the other proxied web applications. To illustrate through FIG. 3, the reverse proxy engine 110 may receive a request message 310 from the web client 205 directed to a particular web application proxied by the reverse proxy system 201. In FIG. 3, the request message 310 is directed to web application B and in the context of a shared session specific to the web client 205. In some examples, the request message 310 includes a proxy session ID, which the reverse proxy engine 110 may parse from the request message 310 and reference to access the session state object 210 specific to the web client 205.

Prior to forwarding the request specified in the request message 310 to web application B, the reverse proxy engine 110 may determine a selected set of updates to the shared session to communicate to web application B. In a general sense, the reverse proxy engine 110 may communicate, to web application B, any changes to the shared session that have occurred since the web client 205 last accessed web application B. Put another way, the reverse proxy engine 110 may communicate an incremental update of the shared session to web application B based on session attribute changes that occurred since the most recent (e.g., previous or last) access of web application B by the web client 205. Such changes to the shared session may have been made by other proxied web applications, the reverse proxy itself, non-proxied applications, the web client 205, or various other sources capable of setting or changing attribute values of the shared session.

Prior to communicating shared session changes to a web application, the reverse proxy engine 110 may determine the particular shared session attributes that have changed in value since the last access to the web application. To do so, the reverse proxy engine 110 may reference the session state object 210 to compare access and modification timestamps. In FIG. 3, the reverse proxy engine 110 may reference the session state object 210 to compare the last-accessed timestamp for web application B with the last-modified timestamps for the shared session attributes that are part of the shared session. For shared session attributes identified with a last-modified timestamp subsequent (e.g., later in time) to the last-accessed timestamp for web application B, the reverse proxy engine 110 may determine to communicate the updated values for these identified shared session attributes to web application B. Accordingly, the reverse proxy engine 110 may identify shared session attributes that have changed since a particular web application was last accessed.

In FIG. 3, the reverse proxy engine 110 determines that a session attribute change for Shared Session Attribute₂ occurred after web application B was last accessed by the web client 205. Responsive to such a determination, the reverse proxy engine 110 may communicate the session attribute change to web application B through a request header of a request message. The reverse proxy engine 110 may process the request message 310 to insert an updated value of Shared Session Attribute₂. In some examples, the reverse proxy engine 110 encodes the session attribute change into an object notation string and inserts the object notation string into a custom field in a request header of the request. The reverse proxy engine 110 may also replace a proxy session ID in the request header with an application session ID specific to web application B. After insertion of the session attribute change (and any other processing), the reverse proxy engine 110 may forward the request message to web application B, shown in FIG. 3 as the request message 320.

In a consistent manner as described above, the reverse proxy engine 110 may communicate shared session changes made by a particular web application to other proxied web applications. Instead of broadcasting every change to the shared session to every other proxied web application, the reverse proxy engine 110 may communicate session attribute changes specifically when a particular web application is accessed by the web client 205. Doing so may increase efficiency and reduce resource consumption, for example by reducing network congestion and reverse proxy processing requirements as compared to broadcast techniques. The reverse proxy engine 110 may nonetheless ensure that an accessed web application utilizes current values of the shared session attributes for the shared session, thus providing the benefits of a shared session while increasing efficiency and reducing resource consumption.

As described above, the reverse proxy engine 110 may maintain a shared session for a web client 205 among multiple web applications. Shared session updates may be identified and communicated through request and response messages exchanged between the web client 205 and proxied web applications. In some implementations, the reverse proxy engine 110 and web applications specify session attribute changes through HTTP headers, such as through JSON strings including keywords indicative of shared session updates. The reverse proxy engine 110 may parse HTTP response messages to identify shared session changes (e.g., via the configured keywords) and communicate updated values to the shared session attributes through HTTP request messages. While HTTP and JSON formats provide but one example implementation, the reverse proxy engine 110 may utilize any transport protocol, object notation format, or other communication forms to identify and propagate updates to a shared session.

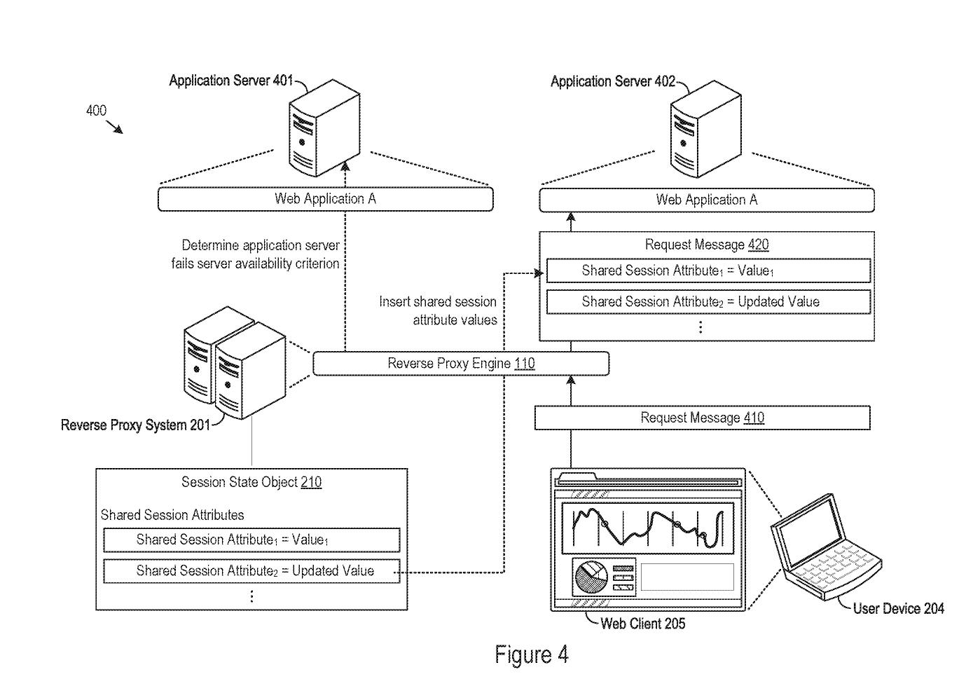

Many of the examples above describe how a reverse proxy engine 110 may maintain a shared session among multiple proxied web applications. In some examples, the reverse proxy engine 110 may additionally or alternatively maintain a shared session among multiple instances of the same web application. Examples of such features are described next with respect to FIG. 4.

FIG. 4 shows an example of an architecture 400 that supports maintaining a shared session among multiple application servers that redundantly host a web application. The architecture 400 in FIG. 4 includes a user device 204 executing a web client 205, a reverse proxy system 201 that includes a reverse proxy engine 110, and the application servers 401 and 402. The application servers 401 and 402 may redundantly host web application A (e.g., as part of the application servers 202 that host web application A in Figures and 3). In that regard, the application servers 401 and 402 may provide different, redundant resources through which web clients may access web application A. In some examples, the application servers 401 and 402 are assigned or configured with different uniform resource locators (URLs), each of which provide access web application A. Thus, redundant hosting of a web application may include utilizing different application servers with redundant URLs that each provide access to the web application.

In operation, the reverse proxy engine 110 may support load-balancing across the multiple instances of web application A. Put another way, the reverse proxy engine 110 may provide various load-balance capabilities to control access to web application A via the application servers 401 and 402 (and any other application servers that redundantly host web application A). To illustrate, the reverse proxy engine 110 may receive a request message from the web client 205 to access web application A, and the request message may lack an application session ID (e.g., is sent without an application session cookie). Such a scenario may occur at the beginning of a session or prior to a first access to web application A by the web client 205. In such cases, the reverse proxy engine 110 may balance access to web application A by assigning a particular URL amongst multiple redundant URLs, the particular URL an assigned route through which the web client 205 accesses web application A.

Both the application session ID and assigned URL to access web application A may be tracked as part of the shared session for the web client 205. As such, the reverse proxy engine 110 may store, in the session state object 210, the application session ID and the assigned URL (e.g., as a route ID or any other route identifier field). For other shared sessions specific to other web clients, the reverse proxy engine 110 may balance distribution across the redundant URLs (and corresponding application servers) that host web application A, and the reverse proxy engine 110 may provide load balancing through round-robin, weighted round robin, random selection, or any other load distribution mechanism.

In some implementations, the reverse proxy engine 110 may address resource failures by redirecting application access from unavailable application servers or unavailable URLs. For example, the reverse proxy engine 110 may monitor the availability of application servers that redundantly host web application A, such as the application servers 401 and 402 of FIG. 4. In doing so, the reverse proxy engine 110 may use any number of monitoring techniques to apply server availability criteria, such as periodic queries or pings, heartbeat monitoring, ad-hoc availability requests, and so on. The reverse proxy engine 110 may perform such server monitoring as a background process, for example on a periodic basis. When a particular application server fails a server availability criterion (e.g., fails to respond to a periodic query or provide a periodic check-in), the reverse proxy engine 110 may adapt the shared sessions in which web clients are routed to the failing or failed application server.

To illustrate through FIG. 4, the reverse proxy engine 110 may initially assign a shared session for web client 205 to access web application A through a redundant URL configured for the application server 401. As such, the session state object 210 may initially store a route ID for web application A as the particular URL assigned to the application server 401.

In monitoring application servers hosting proxied web applications, the reverse proxy engine 110 may determine the application server 401 fails a server availability criterion, which may signal the application server 401 as down and web application A as inaccessible. In response, the reverse proxy engine 110 may reroute access to another application server instead of the application server 401. For example, the reverse proxy engine 110 may update the session state object 210 to indicate the web client 205 accesses the web application A through a different application server among the multiple application servers that redundantly host web application A, e.g., by assigning a different redundant URL for the web client 205 to access web application A. In FIG. 4, the reverse proxy engine 110 may update the session state object 210 to indicate the web client 205 accesses web application A through the URL configured for the application server 402 that redundantly hosts web application A, instead of failed application server 401.

As the web client 205 previously accessed web application A specifically through the application server 401, the application server 402 may not store or otherwise have access to shared session data communicated from previous accesses to web application A. For a subsequent access to web application A through the application server 402, the reverse proxy engine 110 may nonetheless maintain the shared session for the web client 205. The reverse proxy engine 110 may do so by communicating shared session attribute values to application server 402 through a request message received from the web client 205.

To continue the illustration through FIG. 4, the reverse proxy engine 110 may receive a request message 410 from the web client 205 to access web application A after updating the session state object 210 to redirect access from the (failed) application server 401. The reverse proxy engine 110 may insert the shared session into a request header of the request message 410, e.g., by inserting shared session attributes values for the shared session attributes of the shared session. After insertion of the shared session (e.g., attribute values) into the request header, the reverse proxy engine 110 may forward the request message to the application server 402, the request message shown in FIG. 4 as the request message 420.

Thus, the reverse proxy engine 110 may propagate a shared session to a different application server redundantly hosting a particular web application with a first request message sent from the web-client after fail-over. In doing so, the reverse proxy engine 110 may maintain a shared session among multiple application servers redundantly hosting a proxied web application, for example as part of various load-balancing features provided by the reverse proxy engine 110.

Some common-look features that a reverse proxy system may provide are described next.

FIG. 5 shows an example of an architecture 500 that supports insertion of common-look webpage content through a reverse proxy system. The example architecture shown in FIG. 5 includes the application servers 202 hosting web application A, a reverse proxy system 201 that includes a reverse proxy engine 110, and a user device 204 executing a web client 205.

In operation, the reverse proxy engine 110 may adjust content of response messages received from proxied web applications in order to control webpage formatting and displayed content. The reverse proxy engine 110 may do so to configure look or feel customizations into webpage content, e.g., to ensure a common look and feel across multiple different web applications accessible through a common portal application. To adjust content, the reverse proxy engine 110 may parse, insert, or rewrite webpage content included in response messages sent from proxied web applications.

In some examples, the reverse proxy engine 110 may insert a common-look header or footer into webpage content returned from a proxied web application. In FIG. 5, web application A sends the response message 510 to the reverse proxy engine 110 (e.g., a response to a previous request from the web client 205). The response message 510 may include session attribute changes (e.g., as discussed above). The response message 510 may include webpage content 512, which may include any data in the response message 510 for rendering a webpage in the web client 205. As a particular example, webpage content 512 may include any HTML page content returned by web application A.

Web application A may populate the webpage content 512 of the response message 510 without a header or footer. For example, web application A may generate the webpage content 512 to form an incomplete webpage, e.g., leaving space at the top or bottom of a webpage for the reverse proxy engine 110 to insert header and footer data. In some examples, web application A may insert special markup flags into the webpage content 512 indicative of locations at which the reverse proxy engine 110 can insert header or footer data. The reverse proxy engine 110 may identify such special markup flags in processing the response message 510 prior to relaying the response to the web client 205. As another example, the reverse proxy engine 110 may identify positions to insert common-look content in the webpage content 512 at predetermined locations in the webpage content 512. Examples of such predetermined positions include a first child of the HTML <body> element as a header location, a last child as the footer location (e.g., the child immediately preceding the HTML </body> element), or any other preconfigured reference point in HTML body or other webpage content.

The reverse proxy engine 110 may inject common-look elements into the response messages. A common-look element may refer to a common visual element that the reverse proxy engine 110 inserts for webpage content regardless of which proxied web application generated the webpage content. In FIG. 5, the reverse proxy engine 110 inserts a common-look header 522 into a response message from web application A. The response message, with inserted common-look elements, is forwarded to a web client 205, for example as depicted through the response message 520 in FIG. 5. Although the common-look header 522 is shown separately from the webpage content 512 in FIG. 5, the reverse proxy engine 110 may insert the common-look header 522 or any other common-look element within the webpage content 512 itself. Other examples of common-look elements include footers, sidebars, fonts, colors, buttons, input elements, cascading style sheets (CSS) properties, images, and more.

In some implementations, the reverse proxy engine 110 may insert common-look error messages into application responses. Such error messages may correspond to HTML error or condition codes received from proxied web applications, for instance “404 Not Found”, “403 Forbidden”, or “500 Internal Server Error” as but a few examples. The reverse proxy engine 110 may parse response messages from proxied web applications, and adjust webpage content specifically for response with error messages. In doing so, the reverse proxy engine 110 may suppress, block, discard, omit, or otherwise alter application-created error content and instead insert common-look error content into response messages. In this way, the web client 205 may render common error pages for multiple different web applications, e.g., regardless of the particular proxied web application that generated the error response. Thus, error messages or content provide another example of common-look elements that a reverse proxy engine 110 may insert into webpage content.

As described above, reverse proxy systems with reverse proxy engines 110 may maintain a shared session among multiple proxied web applications. Additionally or alternatively, the reverse proxy engine 110 may support insertion of common-look elements into webpage content returned from proxied web applications, which may create a more consistent and uniform experience for users of a portal to access proxied web applications. By providing these features as part of a reverse proxy system, the reverse proxy engine 110 may act as a centralized control point to increase the efficiency at which such features are implemented and effectuated.

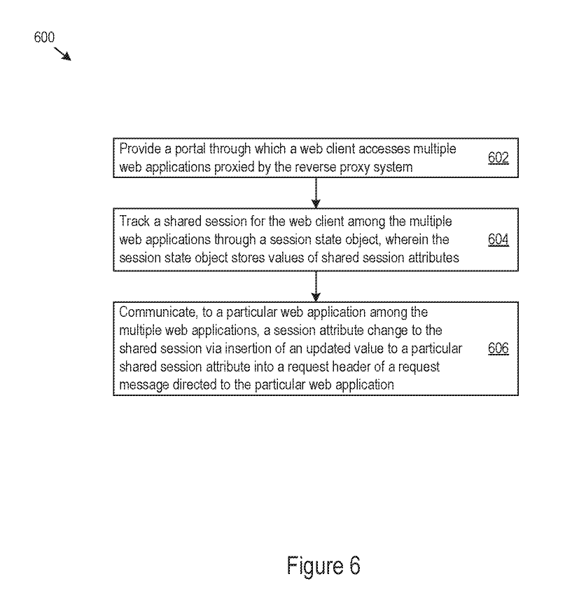

FIG. 6 shows a flow chart of an example method 600 to maintain a shared session among multiple web applications through a reverse proxy system. Execution of the method 600 is described with reference to the reverse proxy engine 110, though any other device, hardware-programming combination, or other suitable computing system may execute any of the steps of the method 600. As examples, the method 600 may be implemented in the form of executable instructions stored on a machine-readable storage medium or in the form of electronic circuitry.

In implementing or performing the method 600, the reverse proxy engine 110 may provide a portal through which a web client accesses multiple web applications proxied by the reverse proxy system (602). The reverse proxy engine 110 may, for instance, host a portal webpage or otherwise implement the portal to provide a common access point to proxied web applications. The reverse proxy engine 110 may also track a shared session for the web client among the multiple web applications through a session state object (604). The session state object may store values of shared session attributes and more. In some examples, the reverse proxy engine 110 may store the session state object locally within a reverse proxy system. Continuing discussion of the method 600, the reverse proxy engine 110 may communicate, to a particular web application among the multiple web applications, a session attribute change to the shared session via insertion of an updated value to a particular shared session attribute into a request header of a request message directed to the particular web application (606).

In some examples, prior to communicating the session attribute change to the particular web application, the reverse proxy engine 110 may receive a request message from the web client to access the particular web application and determine, from the session state object, that the particular shared session attribute was updated by a different web application subsequent to a previous access of the particular web application by the web client. For example, the reverse proxy engine 110 may compare a last-accessed timestamp for the particular web application and last-modified timestamps of shared session attributes, including the particular shared session attribute.

The reverse proxy engine 110 may implement or execute the method 600 further to include receiving a response message from a different web application among the multiple web applications and parsing the response message to identify a session attribute change specified in a response header of the response message. In some examples, the reverse proxy engine 110 may parse the response header for updated values of shared session attributes made by the different web application. The reverse proxy engine 110 may further update the session state object to account for the session attribute change.

The reverse proxy engine 110 may also support shared sessions across redundant application servers and URLs. In some implementations, wherein the particular web application may be redundantly hosted on multiple application servers. In such cases, the reverse proxy engine 110 may determine that a particular application server among the multiple application servers through which the web client accesses the particular web application has failed a server availability criterion. Responsive to such a determination, the reverse proxy engine 110 may update the session state object to indicate the web client accesses the particular web application through a different application server among the multiple application servers that redundantly host the particular web application. After the updating, the reverse proxy engine 110 may receive a different request message from the web client to access the particular web application and insert the values of the shared session attributes stored by the session state object into a request header of the different request message. After the inserting, the reverse proxy engine 110 may forward the different request message to the different application server.

As noted above, the reverse proxy engine 110 may support insertion of common-look elements. Thus, the reverse proxy engine 110 may implement or execute the method 600 further to include receiving a response message from the particular web application, wherein webpage content of the response message does not include a content header; inserting a common-look header into a body of the response message as the content header for the webpage content of the response message; and sending the response message with the inserted common-look header to the web client. Other common-look elements are contemplated as well, such as common-look error pages, footers, sidebars, and more.

Although one example was shown in FIG. 6, the steps of the method 600 may be ordered in various ways. Likewise, the method 600 may include any number of additional or alternative steps, including steps implementing any of the features described herein, including any of the shared session, load-balancing; or common-look features described herein.

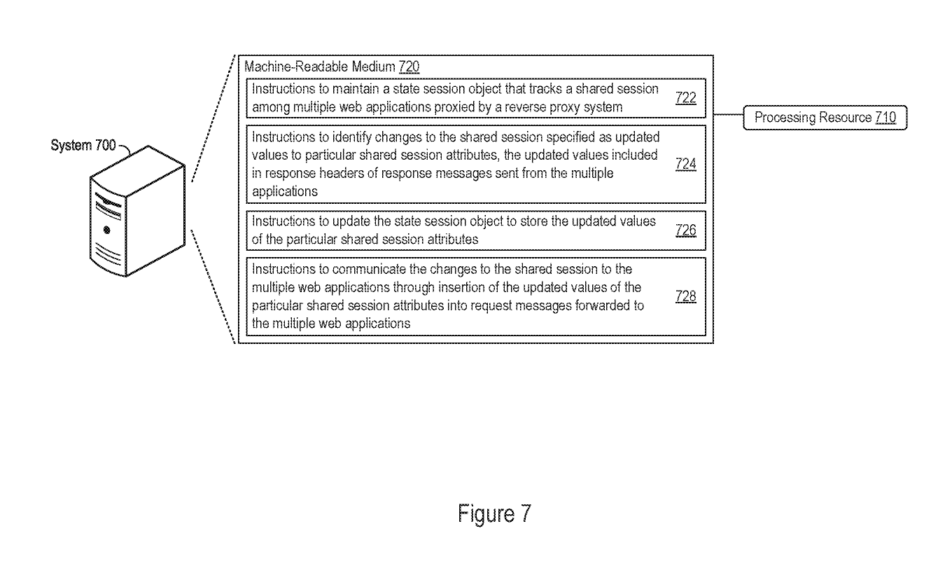

FIG. 7 shows an example of a system 700 that supports maintaining a shared session among multiple web applications. The system 700 may include a processing resource 710, which may take the form of a single or multiple processors. The processor(s) may include a central processing unit (CPU), microprocessor, or any hardware device suitable for executing instructions stored on a machine-readable medium, such as the machine-readable medium 720 shown in FIG. 7. The machine-readable medium 720 may be any non-transitory electronic, magnetic, optical, or other physical storage device that stores executable instructions, such as the instructions 722, 724, 726, and 728 shown in FIG. 7. As such, the machine-readable medium 720 may be, for example, Random Access Memory (RAM) such as dynamic RAM (DRAM), flash memory, memristor memory, spin-transfer torque memory, an Electrically-Erasable Programmable Read-Only Memory (EEPROM), a storage drive, an optical disk; and the like.

The system 700 may execute instructions stored on the machine-readable medium 720 through the processing resource 710. Executing the instructions may cause the system 700 to perform any of the features described herein, including according to any features of the reverse proxy engine 110 or web applications described above.

For example, execution of the instructions 722 by the processing resource 710 may cause the system 700 to maintain a session state object that tracks a shared session among multiple web applications proxied by a reverse proxy system. The shared session may be specific to a web client and the session state object may store values of shared session attributes. Execution of the instructions 724, 726, and 728 by the processing resource 710 may cause the system 700 to identify changes to the shared session specified as updated values to particular shared session attributes, the updated values included in response headers of response messages sent from the multiple applications (instructions 724); update the session state object to store the updated values of the particular shared session attributes (instructions 726); and communicate the changes to the shared session to the multiple web applications through insertion of the updated values of the particular shared session attributes into request messages forwarded to the multiple web applications (728).

In some examples, the instructions 728 may be executable by the processing resource 710 to communicate changes to the shared session to a particular web application among the multiple web applications by receiving a request message from the web client to access the particular web application; identifying; from the session state object, shared session attributes that have changed since the web client last accessed the particular web application; inserting updated values of the shared session attributes that have changed into a request header of the request message from the web client to access the particular web application; and after insertion, forwarding the request message to the particular web application.

In some examples, a particular web application is redundantly hosted on multiple application servers. The machine-readable medium 720 may further store instructions executable by the processing resource 710 to determine that a particular application server among the multiple application servers through which the web client accesses the particular web application has failed a server availability criterion; update the session state object to indicate the web client accesses the particular web application through a different application server among the multiple application servers that redundantly host the particular web application; after the update, receive a request message from the web client to access the particular web application; insert the values of the shared session attributes stored by the session state object into a request header of the request message; and after insertion, forward the request message to the different application server.

As yet another example; the machine-readable medium 720 may further store instructions executable by the processing resource 710 to receive a response message from a particular web application, wherein webpage content of the response message does not include a content sidebar; insert a common-look sidebar into a body of the response message as the content sidebar for the webpage content of the response message; and send the response message with the inserted common-look sidebar to the web client. Other common-look elements are contemplated as well, such as common-look error pages, headers, footers, and more.

The systems, methods, devices, engines, architectures, memory systems, and logic described above, including the reverse proxy engine 110, application servers, and web applications, may be implemented in many different ways in many different combinations of hardware, logic, circuitry, and executable instructions stored on a machine-readable medium. For example, the reverse proxy engine 110, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine readable instructions stored on the medium, which when executed in an endpoint, computer system, or other device, cause the device to perform operations according to any of the description above, including according to any features of the reverse proxy engine 110, web applications, web client, and more.

The processing capability of the systems, devices, and engines described herein, including the reverse proxy engine 110, may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
through a reverse proxy system:
providing a portal through which a web client accesses multiple web applications proxied by the reverse proxy system;
tracking a shared session for the web client among the multiple web applications through a session state object, wherein the session state object stores values of shared session attributes; and
communicating, to a particular web application among the multiple web applications, a session attribute change to the shared session via insertion of an updated value to a particular shared session attribute into a request header of a request message directed to the particular web application.

2. The method of claim 1, further comprising, prior to communicating the session attribute change to the particular web application:
receiving a request message from the web client to access the particular web application; and
determining, from the session state object, that the particular shared session attribute was updated by a different web application subsequent to a previous access of the particular web application by the web client.

3. The method of claim 1, further comprising:
receiving a response message from a different web application among the multiple web applications;
parsing the response message to identify a session attribute change specified in a response header of the response message; and
updating the session state object to account for the session attribute change.

4. The method of claim 3, wherein parsing comprises parsing the response header for updated values of shared session attributes made by the different web application.

5. The method of claim 1, comprising storing the session state object locally within the reverse proxy system.

6. The method of claim 1, further comprising:
receiving a response message from the particular web application, wherein webpage content of the response message does not include a content header;
inserting a common-look header into a body of the response message as the content header for the webpage content of the response message; and
sending the response message with the inserted common-look header to the web client.

7. The method of claim 1, wherein the particular web application is redundantly hosted on multiple application servers, and further comprising:
determining that a particular application server among the multiple application servers through which the web client accesses the particular web application has failed a server availability criterion;
updating the session state object to indicate the web client accesses the particular web application through a different application server among the multiple application servers that redundantly host the particular web application;
after the updating, receiving a different request message from the web client to access the particular web application;
inserting the values of the shared session attributes stored by the session state object into a request header of the different request message; and
after the inserting, forwarding the different request message to the different application server.

8. A reverse proxy system comprising:
a network interface to communicate with a web client and multiple web applications; and
a reverse proxy engine to:
maintain a shared session among the multiple web applications for the web client; and
update the shared session responsive to identifying a session attribute change specified in a response header of a response message from a particular web application among the multiple web applications.

9. The reverse proxy system of claim 8, wherein the reverse proxy engine is further to, after the update to the shared session:
receive a request message from the web client to access a different web application among the multiple web applications; and
insert the session attribute change into a request header of the request message; and
after insertion of the session attribute change into the request header, forward the request message to the different web application.

10. The reverse proxy system of claim 9, wherein the reverse proxy engine is to insert the session attribute change into the request header by:
encoding the session attribute change in an object notation format to obtain an encoded session attribute change string; and
inserting the encoded session attribute change string into a custom field of the request header.

11. The reverse proxy system of claim 8, wherein the reverse proxy engine is further to, after the update to the shared session:
receive a request message from the web client to access a different web application among the multiple web applications; and
identify, from the shared session, a set of session attribute changes that have occurred since the web client previously accessed the different web application;
insert the set of session attribute changes into a request header of the request message; and
after insertion of the set of session attribute changes into the request header, forward the request message to the different web application.

12. The reverse proxy system of claim 8; wherein the reverse proxy engine is to maintain the shared session via storage of a session state object that includes:
values of shared session attributes;
application session identification values for the multiple web applications; and
timestamps that indicate when the multiple web applications were last accessed by the web client.

13. The system of claim 8, wherein the session attribute change identified from the response header specifies an updated value for a particular shared session attribute of the shared session.

14. The reverse proxy system of claim 8, wherein the reverse proxy engine is to identify the session attribute change by:
parsing the response header of the response message to identify a custom header field that specifies the session attribute change; and
determining an updated value for a particular shared session attribute of the shared session; and
wherein the reverse proxy engine is to update the shared session by setting the particular shared session attribute of shared session to the updated value.

15. The reverse proxy system of claim 8, wherein the reverse proxy engine is to further:
receive the response message from the particular web application, wherein webpage content of the response message does not include a content footer;
insert a common-look footer into a body of the response message as the content footer for the webpage content of the response message; and
send the response message with the inserted common-look footer to the web client.

16. The reverse proxy system of claim 8, wherein the particular web application is redundantly hosted on multiple application servers, and wherein the reverse proxy engine is further to:
determine that a particular application server among the multiple application servers through which the web client accesses the particular web application has failed a server availability criterion;
update the shared session to indicate the web client accesses the particular web application through a different application server among the multiple application servers that redundantly host the particular web application;
after the update, receive a request message from the web client to access the particular web application;
insert the shared session into a request header of the request message; and
after insertion of the shared session into the request header, forward the request message to the different application server.

17. A non-transitory machine-readable medium storing instructions executable by a processing resource to:
maintain a session state object that tracks a shared session among multiple web applications proxied by a reverse proxy system, wherein the shared session is specific to a web client and the session state object stores values of shared session attributes;
identify changes to the shared session specified as updated values to particular shared session attributes, the updated values included in response headers of response messages sent from the multiple applications;
update the session state object to store the updated values of the particular shared session attributes; and
communicate the changes to the shared session to the multiple web applications through insertion of the updated values of the particular shared session attributes into request messages forwarded to the multiple web applications.

18. The non-transitory machine-readable medium of claim 17, wherein the instructions are executable by the processing resource to communicate changes to the shared session to a particular web application among the multiple web applications by:
receiving a request message from the web client to access the particular web application;
identifying, from the session state object, shared session attributes that have changed since the web client last accessed the particular web application;
inserting updated values of the shared session attributes that have changed into a request header of the request message from the web client to access the particular web application; and
after insertion, forwarding the request message to the particular web application.

19. The non-transitory machine-readable medium of claim 17, wherein a particular web application is redundantly hosted on multiple application servers, and wherein the non-transitory machine-readable medium further stores instruction executable by the processing resource to:
determine that a particular application server among the multiple application servers through which the web client accesses the particular web application has failed a server availability criterion;
update the session state object to indicate the web client accesses the particular web application through a different application server among the multiple application servers that redundantly host the particular web application;
after the update, receive a request message from the web client to access the particular web application;
insert the values of the shared session attributes stored by the session state object into a request header of the request message; and
after insertion, forward the request message to the different application server.

20. The non-transitory machine-readable medium of claim 17, further storing instructions executable by the processing resource to;
receive a response message from a particular web application, wherein webpage content of the response message does not include a content sidebar;
insert a common-look sidebar into a body of the response message as the content sidebar for the webpage content of the response message; and
send the response message with the inserted common-look sidebar to the web client.
